(19) United States
(12) Patent Application Publication
(10) Pub. No.: US 2003/0231254 A1
(43) Pub. Date: Dec. 18, 2003

(54) Data recording apparatus and data recording method

(75) Inventors: Kazuto Yoneyama, Yokohama (JP); Junji Shiokawa, Chigasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/464,005

(22) Filed: Jun. 17, 2003

(30) Foreign Application Priority Data
Jun. 17, 2002 (JP) 2002-175168

(51) Int. Cl. H04N 5/76; H04N 5/225

(52) U.S. Cl. 348/333.01; 386/46; 386/117

(57) ABSTRACT

Disclosed is a technology that employs such plural display means as a monitor and a viewfinder to allow a user to record display information onto an information recording medium in handy and user-friendly manner, wherein different pieces of information are output to the plural display means depending on positional state of either of the display means. In a normal state of the monitor, the same information is displayed on both the monitor and the viewfinder, while in an inverted state of the monitor, information displayed on the monitor is different from information displayed on the viewfinder.

### BACKGROUND OF THE INVENTION

The present invention relates to a technology for recording information onto an information recording medium, specifically to the technology that allows a user to record the information onto the medium in a user-friendly manner.

A conventional video camera as an information recording apparatus has such a display means as a Liquid Crystal Display (LCD), and most of such types of the camera are structured to be equipped with both a viewfinder and a monitor. The viewfinder is for the user to view an object by looking through a hole provided on the main body of the camera, while the monitor is provided separately from the viewfinder. This enables the user to adjust an angle of the monitor freely in such a way that the image of the object is viewed not only by a cameraman but also by a person as the object.

The viewfinder is a display means for the cameraman to grasp picture information through a lens in taking a picture, while the monitor is also a display means but used by the cameraman and the person serving as the object for grasping picture information through the lens. However, the conventional video camera structured such that the information displayed on the viewfinder is the same as the one displayed on the monitor, suffers from a problem in which the display information needed only for the cameraman is displayed on the monitor through which the person as the object can look it, on the other hand, the display information needed only for the person as the object is displayed on the viewfinder through which the cameraman can look it.

### SUMMARY OF THE INVENTION

The present invention aims at providing a technology for recording information onto an information recording medium, specifically the technology that allows a user to record the information onto the medium in a user-friendly manner.

To achieve this, one aspect of the invention resides in an information recording apparatus having a first display means and a second display means both for displaying display information. The apparatus is structured such that depending on the types of the information, it displays information on the first display means different from the one on the second display means. Note the types of the information are two that is picture information through the picture information acquisition means and information owned by the apparatus.

Other and further objects, features and advantages of the invention will appear more fully from the following description.

### BRIEF DESCRIPTION OF THE DRAWINGS

FIG. 1 is a block diagram showing the overall configuration of a video camera implemented by a first embodiment;

FIG. 2 is a diagram showing a perspective side view of a state of the video camera;

FIG. 3 is a diagram showing states of a monitor 115;

FIG. 4 is an explanatory diagram showing display information;

FIG. 5 is an explanatory diagram showing a table of a control unit 114;

FIG. 6 is an explanatory diagram showing another table of the control unit 114;

FIG. 7 is an explanatory diagram showing a further table of the control unit 114;

FIG. 8 is a block diagram showing a typical configuration of a picture processing unit 104;

FIG. 9 is an explanatory diagram showing other display information; and

FIG. 10 is an explanatory diagram showing further display information.

### DETAILED DESCRIPTION OF THE PREFERRED EMBODIMENTS

A first embodiment of the present invention is explained as follows. Note an information recording apparatus implemented by the embodiment is a video camera for recording picture information and audio information onto an optical disc. It is also worth noting that, while the video camera is capable of reproducing information from an optical disc, this capability is not an intrinsic nature of the present invention so that details of a picture generation process are not explained.

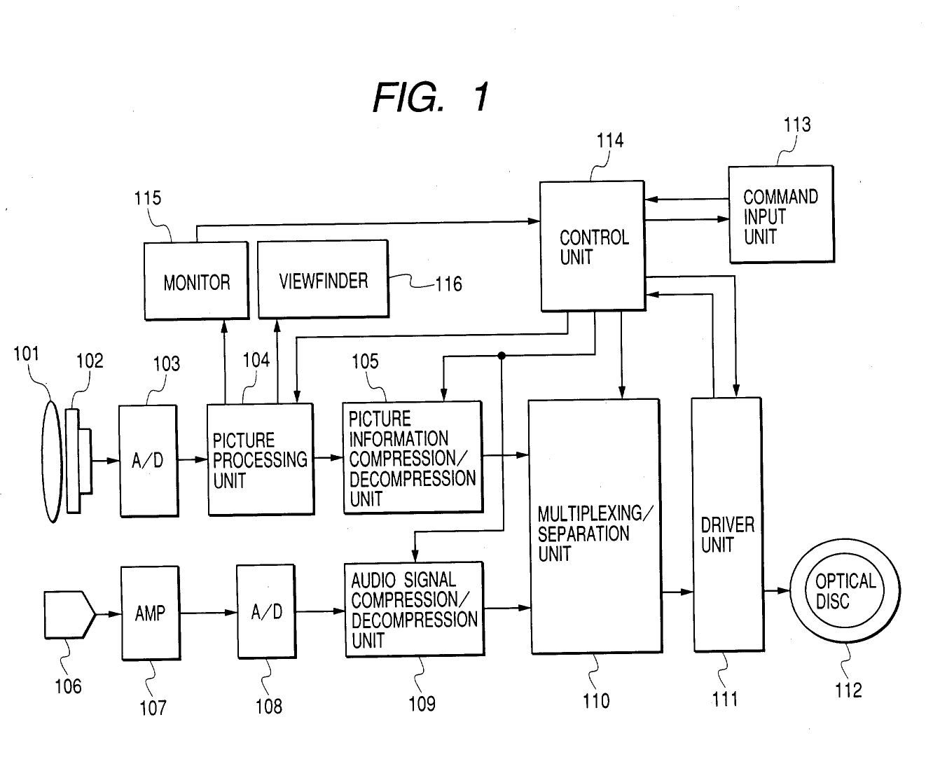

The overall configuration of a video camera implemented by a first embodiment is explained by referring to FIG. 1. A lens 101 shown in FIG. 1 is a lens receiving picture information. A CCD (Charge Couple Device) 102 is a device for converting the picture information received by the lens 101 as an optical signal into an electrical analog signal representing the picture information. An A/D (Analog to Digital) converter 103 is a device for converting the electrical analog signal generated by the CCD 102 as a result of conversion into a digital signal. A picture information processing unit 104 is a component for storing the digital signal generated by the A/D converter 103 as a result of conversion to be output later to a picture information compression/decompression unit 105. A display means 115 is a monitor while a display means 116 is a viewfinder. The display means 115 and 116 are each a component for displaying information output by the picture information processing unit 104. The picture information compression/decompression unit 105 compresses information received from the picture information processing unit 104 by adoption of an MPEG (Motion Picture Experts Group) technique. An AMP (Amplitude Modulation) unit 107 is a component for amplifying an audio signal received from a mike 106. An A/D converter 108 is a component for converting an analog signal generated by the AMP unit 107 as a result of amplification into a digital signal. An audio signal compression/decompression unit 109 is a component for compressing a digital signal generated by the A/D converter 108 as a result of conversion by adoption of typically the MPEG technique or a Dolby digital technique. A multiplexing/separation unit 110 is a component for multiplexing elementary streams output by the picture information compression/decompression unit 105 and the analog signal compression/decompression unit 109 to produce a system stream conforming to the MPEG technique. A driver unit 111 is a component for recording the system stream generated by the multiplexing/separation unit 110 as a result of multiplexing onto an optical disc 112 in a way depending on the type of the optical disc 112. The optical disc 112 is an optical disc, on which data is recorded by the driver unit 111. A command input unit 113 is a component through which a command is entered to the video camera. A control unit 114 is a component for interpreting a command input from the command input unit 113 and controlling the picture information processing unit 104, the picture information compression/decompression unit 105, the analog signal compression/decompression unit 109, the multiplexing/separation unit 110 and the driver unit 111 in accordance with a result of the interpretation of the command.

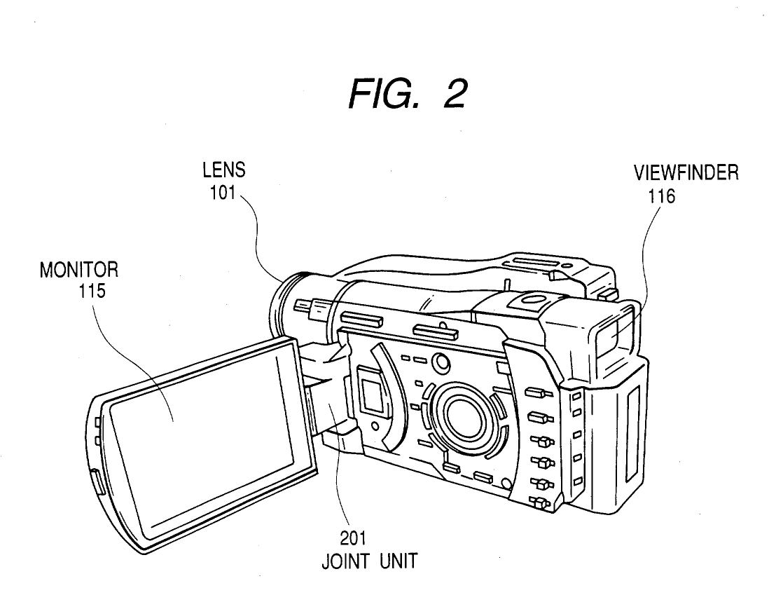

The external appearance of the video camera is explained by referring to FIG. 2. The lens 101 shown in FIG. 2 receives picture information. Display information generated from the picture information received by the lens 101 and other information is displayed on the monitor 115 and the viewfinder 116. A joint unit 201 is a component for joining the main body of the video camera to the monitor 115. Details of the display information will be described later.

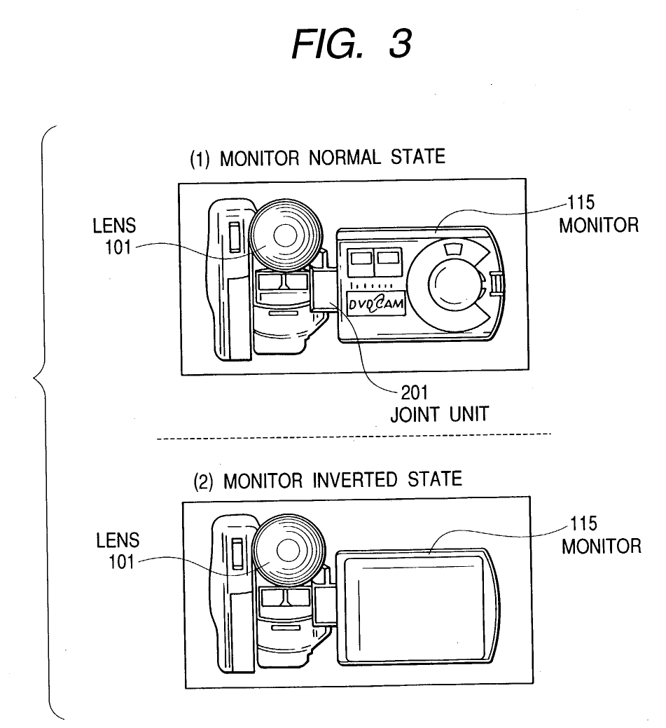

A positional state of the monitor 115 is explained by referring to FIG. 3. FIG. 3 (1) shows a normal state of the monitor 115. In the normal state, the monitor 115 is opened. In the following description, this normal state is referred to as a monitor normal state. FIG. 3 (2) shows a state in which the monitor 115 is put in a turned around posture allowing the object of imaging to be seen from the imaged object side. In the following description, this turned around state is referred to as a monitor inverted state. In the joint unit 201, there is provided a switch not shown in the figure. The switch is turned on and off, when the state of the monitor 115 changes normal state and inverted state. The control unit 114 shown in FIG. 1 is capable determining whether the monitor 115 has been put in the monitor normal state or the monitor inverted state by recognizing whether the switch has been put in an ON or OFF state.

In this embodiment, with the monitor 115 put in the monitor normal state, the picture information processing unit 104 outputs the same display information to both the monitor 115 and the viewfinder 116. In the monitor inverted state, on the other hand, the picture information processing unit 104 outputs different pieces of display information to the monitor 115 and the viewfinder 116.

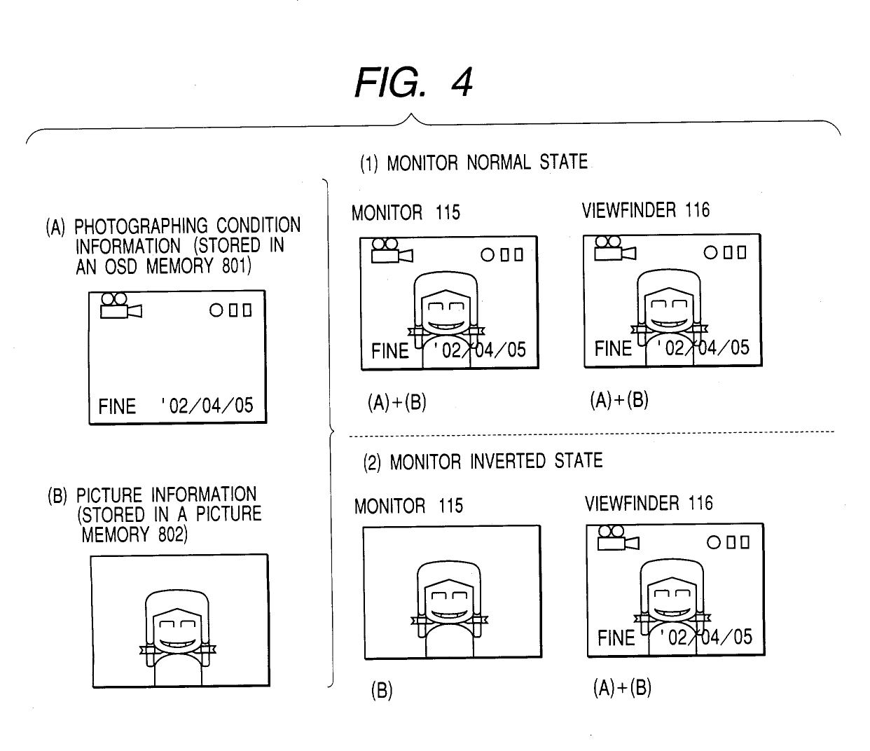

The display information is explained by referring to FIG. 4. FIG. 4 is a diagram showing pieces of display information appearing on the monitor 115 and the viewfinder 116 in the monitor normal state and the monitor inverted state.

FIG. 4 (A) shows information on conditions of imaging such as a imaging date and a imaging mode. FIG. 4 (B) shows picture information received from the lens 101. In the monitor normal state, the picture information and the information on conditions of imaging each appear on the monitor 115 as well as the viewfinder 116 as display information as shown in FIG. 4 (1). In the monitor inverted state, on the other hand, only the picture information appears on the monitor 115 as display information but the picture information and the information on conditions of imaging each appear on the viewfinder 116 as display information as shown in FIG. 4 (2).

This is because, in the monitor normal state, only the cameraman is viewing the display information appearing on both the monitor 115 and the viewfinder 116 but, in the monitor inverted state, the viewer of the display information appearing on the monitor 115 is different from the viewer of the display information appearing on the viewfinder 116 in many cases.

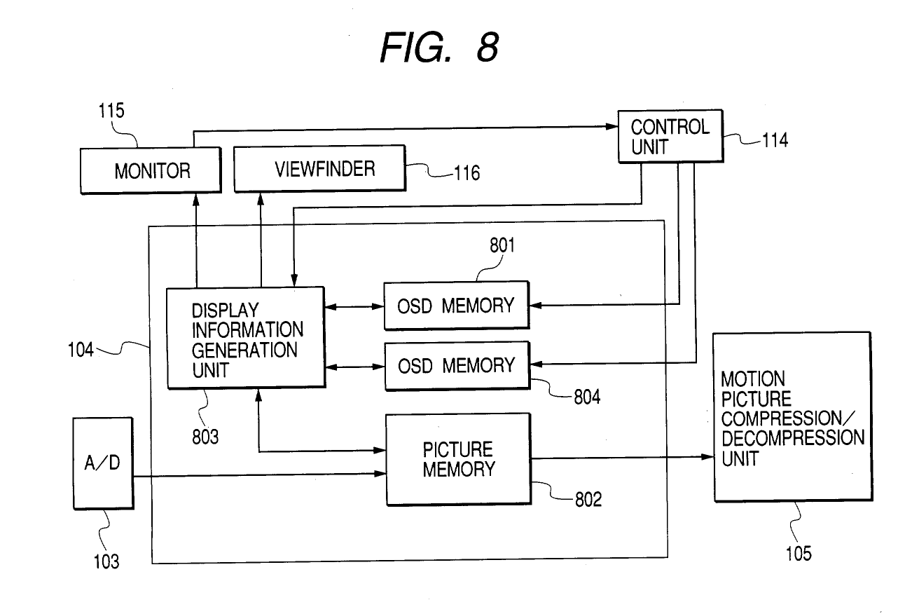

Referring to FIG. 8, the following description explains a typical configuration of the video camera for outputting pieces of display information like the ones shown in FIG. 4.

FIG. 8 shows a typical configuration of the picture information processing unit 104 employed in the video camera shown in FIG. 1. An OSD (On Screen Display) memory 801 is a device for storing the aforementioned information on conditions of imaging. The information on conditions of imaging stored in the OSD memory 801 is updated by a control unit 114 when a condition of imaging changes. A picture information memory 802 is a device for storing picture information through the lens 101. The picture information stored in the picture information memory 802 is updated from time to time whenever new picture information is input. A display information generation unit 803 is a component for reproducing pieces of display component to be output to the monitor 115 and the viewfinder 116 from information on conditions of imaging stored in the OSD memory 801 and the picture information stored in the picture information memory 802 in accordance with the state of the monitor 115. Note, in FIG. 8, components identical with their counterparts shown in FIG. 1 are denoted by the same reference numerals as the counterparts.

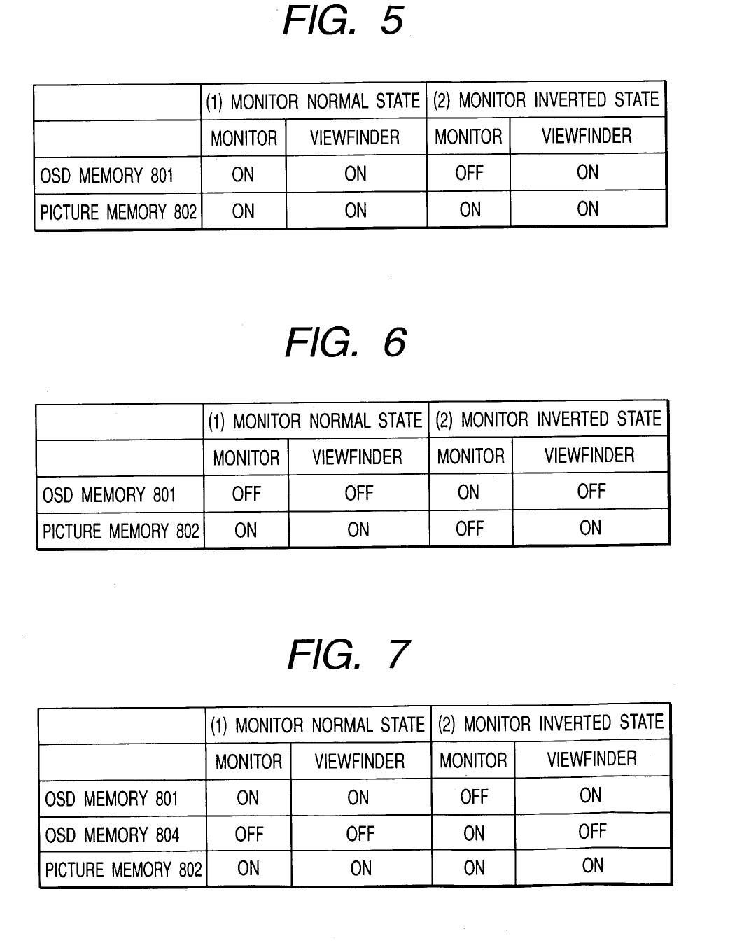

Referring to FIGS. 5 and 8, the following description explains operations carried out by the video camera to output pieces of display information like the ones shown in FIG. 4. The control unit 114 stores information on conditions of imaging into the OSD memory 801. Then, the control unit 114 determines whether the monitor 115 has been put in the monitor normal state or the monitor inverted state by recognizing whether the switch employed in the joint unit 201 has been put in an ON or OFF state. Subsequently, on the basis of the state of the monitor 115, the control unit 114 outputs a command to the display information generation unit 803, requesting the display information generation unit 803 to generate pieces of display information to be displayed on the monitor 115 and the viewfinder 116 in accordance with a table shown in FIG. 5. This table is included in the control unit 114. FIG. 5 (1) shows the table's portion corresponding to the monitor normal state of the monitor 115. As described above, the monitor normal state of the monitor 115 is recognized by the control unit 114. On the other hand, FIG. 5 (2) shows the table's portion corresponding to the monitor inverted state of the monitor 115. By the same token, the monitor inverted state of the monitor 115 is recognized by the control unit 114 as described above. Then, from the information on conditions of imaging stored in the OSD memory 801 and the picture information stored in the picture information memory 802, the display information generation unit 803 generates pieces of display component to be output to the monitor 115 and the viewfinder 116 in accordance with the state of the monitor 115.

Specifically, in the monitor normal state, data of the portion shown in FIG. 5 (1) is set at ON at the intersection of the row of the OSD memory 801 and the column of the monitor 115, meaning that information on conditions of imaging stored in the OSD memory 801 is to be displayed on the monitor 115. By the same token, ON data at the intersection of the row of the OSD memory 801 and the column of the viewfinder 116 means that information on conditions of imaging stored in the OSD memory 801 is to be displayed on the viewfinder 116. In the same way, ON data at the intersection of the row of the picture information memory 802 and the column of the monitor 115 means that picture information stored in the picture information memory 802 is to be displayed on the monitor 115. Likewise, ON data at the intersection of the row of the picture information memory 802 and the column of the viewfinder 116 means that picture information stored in the picture information memory 802 is to be displayed on the viewfinder 116. Refer to FIG. 4 (1).

In the monitor inverted state, on the other hand, data of the portion shown in FIG. 5 (2) is set at OFF at the intersection of the row of the OSD memory 801 and the column of the monitor 115, meaning that information on conditions of imaging stored in the OSD memory 801 is not to be displayed on the monitor 115. By the same token, ON data at the intersection of the row of the OSD memory 801 and the column of the viewfinder 116 means that information on conditions of imaging stored in the OSD memory 801 is to be displayed on the viewfinder 116. In the same way, ON data at the intersection of the row of the picture information memory 802 and the column of the monitor 115 means that picture information stored in the picture information memory 802 is to be displayed on the monitor 115. Likewise, ON data at the intersection of the row of the picture information memory 802 and the column of the viewfinder 116 means that picture information stored in the picture information memory 802 is to be displayed on the viewfinder 116. Refer to FIG. 4 (2).

As described above, it is possible to display information proper for the monitor 115 on the monitor 115 and information proper for the viewfinder 116 on the viewfinder 116 in accordance with the state of the monitor 115 as shown in FIG. 4.

In the first embodiment described above, different pieces of display information can be displayed on a plurality of display means in accordance with the state of one of the display means. Thus, it is possible to provide an information recording apparatus that can be used as the user pleases.

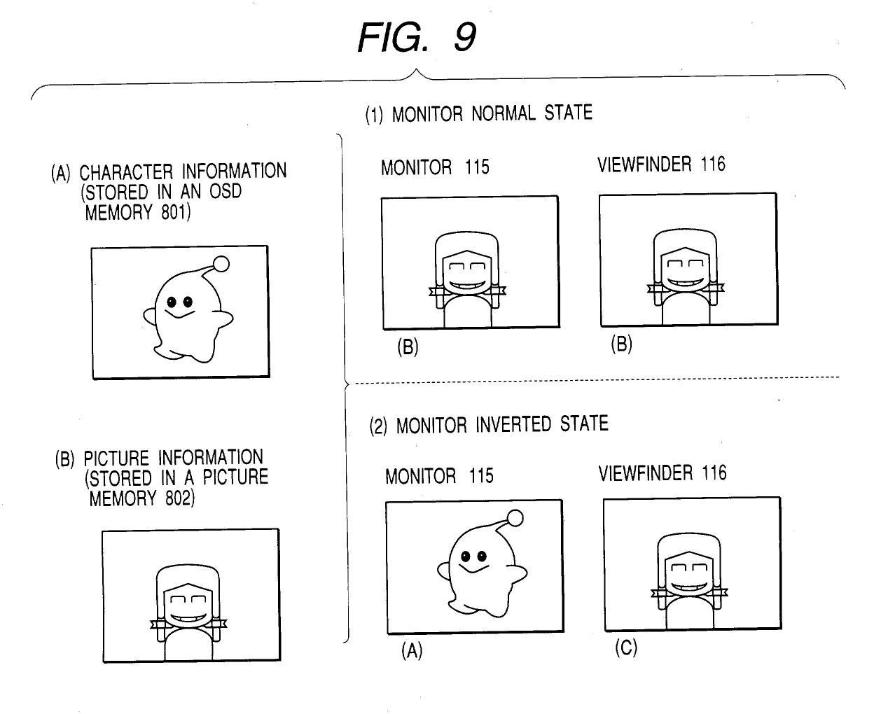

A second embodiment of the present invention is explained by referring to FIGS. 6, 8 and 9 as follows. In the case of the second embodiment, pieces of display information shown in FIG. 9 are displayed on the monitor 115 and the viewfinder 116. In the monitor normal state, picture information appears on the monitor 115 as well as the viewfinder 116 as shown in FIG. 9 (1) as display information. In the monitor inverted state, on the other hand, the picture information appears on the viewfinder 116 as display information but character information appears on the monitor 115 as display information as shown in FIG. 9 (2). In order to display pieces of display information as such, the control unit 114 shown in FIG. 8 is provided with a table shown in FIG. 6, and is put in a configuration wherein the character information is stored in OSD memory 801 while the picture information is stored in the picture information memory 802. To explain the table shown in FIG. 6 in more detail, FIG. 6 (1) shows the table's portion corresponding to the monitor normal state of the monitor 115. As described above, the monitor normal state of the monitor 115 is recognized by the control unit 114. On the other hand, FIG. 6 (2) shows the table's portion corresponding to the monitor inverted state of the monitor 115. By the same token, the monitor inverted state of the monitor 115 is recognized by the control unit 114 as described above. Much like the first embodiment, the control unit 114 determines whether the monitor 115 has been put in the monitor normal state or the monitor inverted state by recognizing whether the switch employed in the joint unit 201 has been put in an ON or OFF state. Subsequently, on the basis of the state of the monitor 115, the control unit 114 outputs a command to the display information generation unit 803, requesting the display information generation unit 803 to generate pieces of display information to be displayed on the monitor 115 and the viewfinder 116 in accordance with the table shown in FIG. 6 in the same way as the first embodiment. As a result, it is possible to display information proper for the monitor 115 on the monitor 115 and information proper for the viewfinder 116 on the viewfinder 116 in accordance with the state of the monitor 115 as shown in FIG. 9.

In the case of the second embodiment described above, in the monitor inverted state, character information can be displayed on the monitor 115 as picture information instead of displaying the true picture information. Assume for example that a picture of a child is taken. In this case, character information is displayed on the monitor 115 to attract the child's attention to the digital camera, arouse the child's interest in the information appearing on the monitor 115 and make the child look at the lens. Thus, there is exhibited an effect of contribution to successful imaging of the child posing with a smile. As a result, it is possible to provide an information recording apparatus that can be used as the user pleases.

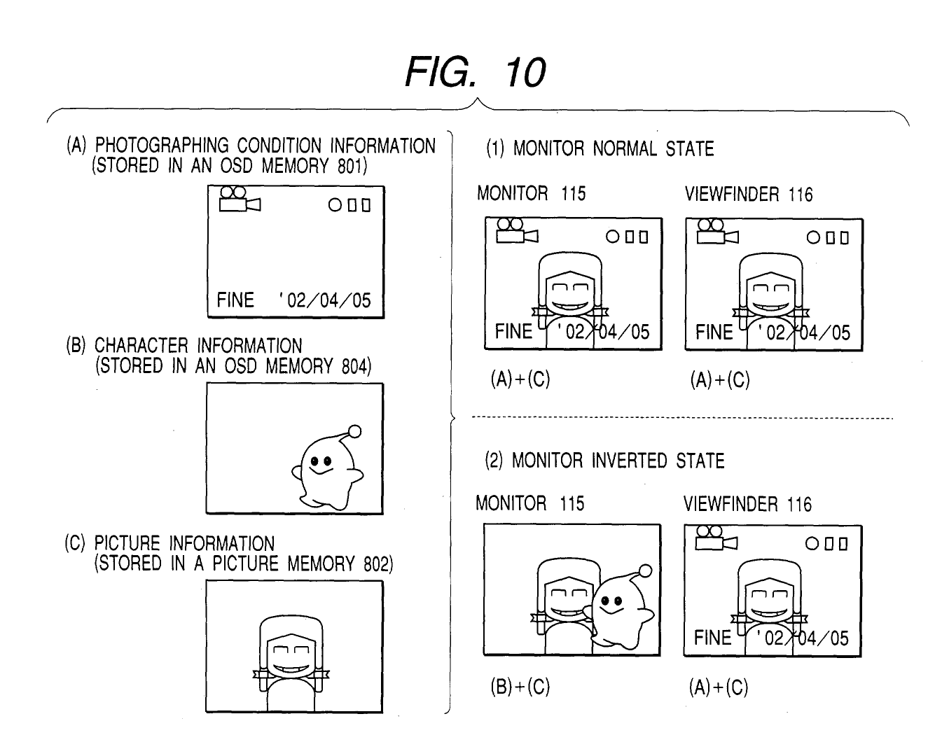

A third embodiment of the present invention is explained by referring to FIGS. 7, 8 and 10 as follows. In the case of the third embodiment, pieces of display information shown in FIG. 10 are displayed on the monitor 115 and the viewfinder 116. As shown in FIG. 10, in the case of the third embodiment, the monitor 115 and the viewfinder 116 display any combination of picture information, information on conditions of imaging and character information. To be more specific, in the monitor normal state, the picture information and the information on conditions of imaging each appear on the monitor 115 as well as the viewfinder 116 as display information as shown in FIG. 10 (1). In the monitor inverted state, on the other hand, the picture information and the character information each appear on the monitor 115 as display information but the picture information and the information on conditions of imaging each appear on the viewfinder 116 as display information as shown in FIG. 10 (2).

In order to display combinations of information as such, the control unit 114 employed in the picture information processing unit 104 shown in FIG. 8 is provided with a table shown in FIG. 7, whereas the picture information processing unit 104 is provided with a configuration including the picture memory 802, the OSD memory 801 and an OSD memory 804. In this case, the information on conditions of imaging is stored in OSD memory 801, the picture information is stored in the picture information memory 802 and the character information is stored in the OSD memory 804. To explain the table shown in FIG. 7 in more detail, FIG. 7 (1) shows the table's portion corresponding to the monitor normal state of the monitor 115. As described above, the monitor normal state of the monitor 115 is recognized by the control unit 114. On the other hand, FIG. 7 (2) shows the table's portion corresponding to the monitor inverted state of the monitor 115. By the same token, the monitor inverted state of the monitor 115 is recognized by the control unit 114 as described above. Much like the first embodiment, the control unit 114 determines whether the monitor 115 has been put in the monitor normal state or the monitor inverted state by recognizing whether the switch employed in the joint unit 201 has been put in an ON or OFF state. Subsequently, on the basis of the state of the monitor 115, the control unit 114 outputs a command to the display information generation unit 803, requesting the display information generation unit 803 to generate pieces of display information to be displayed on the monitor 115 and the viewfinder 116 in accordance with the table shown in FIG. 7 in the same way as the first embodiment. As a result, it is possible to display information proper for the monitor 115 on the monitor 115 and information proper for the viewfinder 116 on the viewfinder 116 in accordance with the state of the monitor 115 as shown in FIG. 10. To put it in detail, it is possible to display information proper for the monitor 115 on the monitor 115 and information proper for the viewfinder 116 on the viewfinder 116 in accordance with the ON and OFF data in the table shown in FIG. 7 for the OSD memory 801, the OSD memory 804 and the picture information memory 802.

As described above, in the case of the third embodiment, information is displayed in accordance with the state of the monitor 115 as shown in FIG. 10. Assume for example that a picture of a child is taken. In this case, character information is displayed on the monitor 115 to attract the child's attention to the digital camera, arouse the child's interest in the information appearing on the monitor 115 and make the child look at the lens. Thus, there is exhibited an effect of contribution to successful imaging of the child posing with a smile. In addition, the cameraman is capable of grasping information on conditions of imaging. As a result, it is possible to provide an information recording apparatus that can be used as the user pleases.

In the first to third embodiments described above, a process is carried out to generate display information after the start of an operation to record picture information and/or audio information onto a recording medium. However, the process to generate display information can also be carried out before the start of an operation to record picture information and/or audio information onto a recording medium in the first to third embodiments. In addition, it is also possible to carry out a pre start process to generate display information prior to the start of an operation to record picture information and/or audio information onto a recording medium and a post start process to generate display information after the start of an operation to record picture information and/or audio information onto a recording medium wherein the post start process is different from the pre start process. Moreover, the first to third embodiments described above have a configuration in which different pieces of display information are displayed depending on the state of the display means. However, the pieces of display information are not limited to what is explained before. Furthermore, the apparatus' configuration for outputting display information is not limited to the first to third embodiments. Any configuration for outputting display information can be used as long as the configuration is capable of outputting display information depending on the state of the display means.

As described above, the present invention allows information to be recorded as the user pleases.

The foregoing invention has been described in terms of preferred embodiments. However, those skilled, in the art will recognize that many variations of such embodiments exist. Such variations are intended to be within the scope of the present invention and the appended claims.

What is claimed is:

1. A recording apparatus for recording information onto an information recording medium, comprising:
a first display means for displaying information;
a second display means for displaying information;
a picture information acquisition means for acquiring picture information; and
a display information generation means for generating information to be displayed on the first display means and the second display means from picture information output by the picture information acquisition means or information owned by the recording apparatus,
wherein the first display means displays different information from the information displayed on the second display means.

2. The recording apparatus according to claim 1, wherein
the first display means is movable; and
the first display means displays different information from the information displayed on the second display means depending on the state of the first display means.

3. The recording apparatus according to claim 1, further comprising a lens through which picture information of an object is input, wherein the recording apparatus is structured such that:
when the display screen of the first display means is turning toward the lens, the first display means displays different information from the information displayed on the second display means; while when the display screen of the first display means is not turning toward the lens, the first display means displays identical information to the information displayed on the second display means.

4. The recording apparatus according to claim 3, having the lens, the first display means, and the second display means arranged in a direction starting from a position close to the imaging object to a position far from the imaging object.

5. The recording apparatus according to claim 1, wherein
the first display means is a monitor,
the second display means is a viewfinder, and
the information owned by the recording apparatus is information on conditions of imaging or character information.

6. A recording method which allows an information recording apparatus comprising a first display means and a second display means both for displaying information to record information onto an information recording medium, the method comprising the steps of:
acquiring picture information; and
generating information to be displayed on the first display means and the second display means from acquired picture information or information owned by the recording apparatus,
Wherein the first display means displays different information from the information displayed on the second display means.

7. The recording method according to claim 6, wherein
the first display means is movable; and
the first display means displays different information from the information displayed on the second display means depending on the state of the first display means.

8. The recording method according to claim 7, wherein the recording apparatus is provided with a lens through which picture information of a object is input, wherein
when the display screen of the first display means is turning toward the lens, the first display means displays different information from the information displayed on the second display means; while when the display screen of the first display means is not turning toward the lens, the first display means displays identical information to the information displayed on the second display means.

9. The recording method according to claim 8, wherein
the lens, the first display means, and the second display means are arranged in distance order of from closest to farthest in regard to the object.

10. The recording method according to claim 6 wherein
the first display means is a monitor;
the second display means is a viewfinder; and
the information owned by the recording apparatus is information on conditions of imaging or character information.
